(19) United States
(12) Patent Application Publication
(10) Pub. No.: US 2013/0242192 A1
(43) Pub. Date: Sep. 19, 2013

(54) TELEVISION DEVICE AND TELEVISION CONTROL METHOD

(71) Applicants: HONG-SHENG CHEN, Tu-Cheng (TW); TIEN-YU LIN, Tu-Cheng (TW)

(72) Inventors: HONG-SHENG CHEN, Tu-Cheng (TW); TIEN-YU LIN, Tu-Cheng (TW)

(73) Assignee: HON HAI PRECISION INDUSTRY CO., LTD., Tu-Cheng (TW)

(21) Appl. No.: 13/483,068

(22) Filed: May 30, 2012

(30) Foreign Application Priority Data
Mar. 14, 2012 (TW) 101108752

(51) Int. Cl. H04N 5/445

(52) U.S. Cl. 348/563; 348/E05.099

(57) ABSTRACT

An exemplary television control method includes receiving signal. Then, the method determines that the applications of the television device are associated with shortcut icons upon receiving a first signal. The method next obtains the shortcut icons of the determined applications. And then the method controls the display unit to display an interface showing selectable shortcut icons according to the obtained shortcut icons of the determined applications, and make the displayed shortcut icons selectable.

### BACKGROUND

1. Technical Field

The present disclosure relates to televisions device and television control methods, and particularly, to a television device capable of quickly entering into one application of the TV when one program is shown on a display unit and a television control method.

2. Description of Related Art

The current television system designed by Google, Inc. integrates android operation system, and is programmed with a number of applications to provide a number of functions, such as gaming, email, and downloading, for example. The television system includes a television mode and an application mode. In the television mode, a television program is shown on the current television device. In the application mode, the television system provides an interface to display the icons corresponding to the applications of the television device for the user to select. When a television program is shown on the television device, and if the user wants to execute one application, the user must first switch from the television mode to the application mode, and further control a box to change up/down/left/right to select one current application, and then enter into the selected current application, which is inefficient.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a television control system in accordance with an exemplary embodiment.

FIG. 2 is a block diagram of a television device in accordance with an exemplary embodiment.

FIG. 3 is a schematic view showing an interface of the television device of FIG. 2.

FIG. 4 is similar to FIG. 3, and showing another interface of the television device of FIG. 2.

FIG. 5 is a flowchart of a television control method in accordance with an exemplary embodiment.

### DETAILED DESCRIPTION

The embodiments of the present disclosure are now described in detail, with reference to the accompanying drawings.

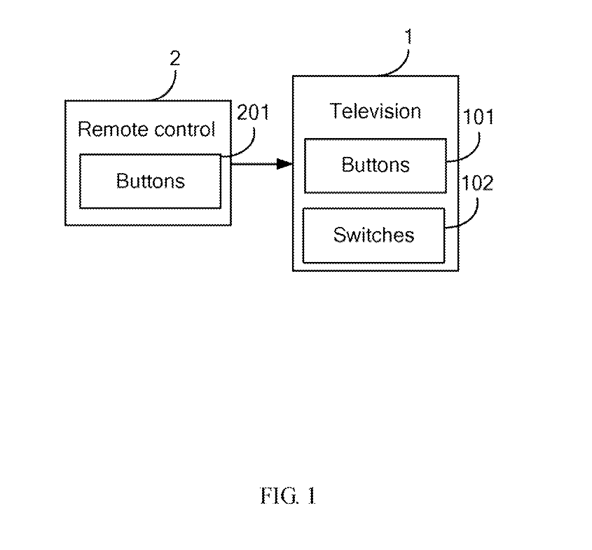

FIG. 1 is a schematic diagram illustrating a television device 1. The television device 1 can be operated by several buttons 201 of a remote control 2 and/or several buttons 101 on the television device 1. The television device 1 can run a number of applications that provide different functions, such as games, email processing, and downloading, for example. Shortcuts can be created to quickly launch the applications associated to shortcut icons 110 which allow a user to launch the applications. The shortcuts may be created in response to a user operation or automatically created for a preset number of most frequently used applications. In the embodiment, the television device 1 integrates Andriod® operating system. When a television program is shown on the television device 1, the television device 1 displays shortcut icons 110 of applications in response to user operations by remote control 2 or buttons 101.

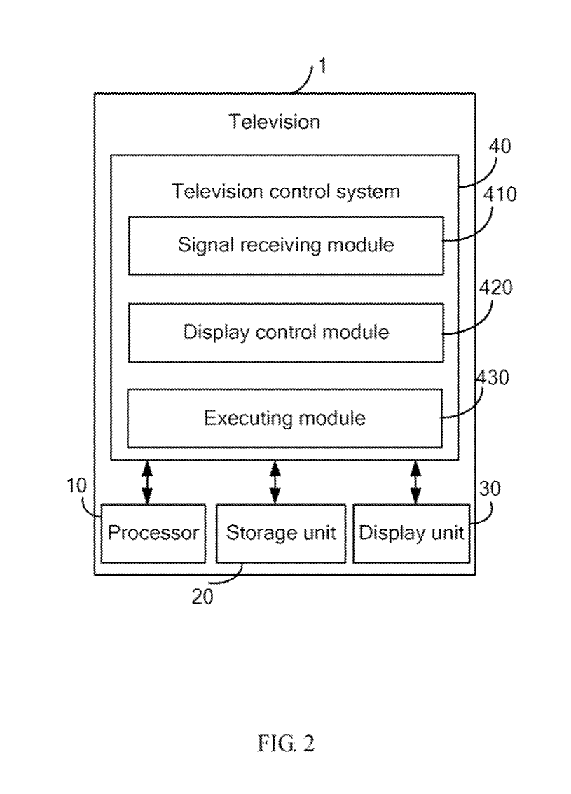

FIG. 2, illustrates the television device 1 including a processor 10, a storage unit 20, a display 30, and a television control system 40. In the embodiment, the television control system 40 includes a signal receiving module 410 and a display control module 420. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The signal receiving module 410 receives signals. The display control module 420 determines the applications of the television device 1 which are associated with which of the shortcut icons 110 when the signal receiving module 410 receives a first signal, obtains the shortcut icons 110 of the determined applications of the television device 1, and further controls the display unit 30 to display an interface 100 showing a number of selectable shortcut icons 110 according to the obtained one or more shortcut icons 110 of the determined applications, and make the displayed one or more shortcut icons 110 selectable. In the embodiment, the display control module 420 further controls the display unit 30 to display a box 120 covering one selectable shortcut icon 110 to indicate that the one selectable shortcut icon 110 is a currently highlighted shortcut icon 110, which is currently selected.

In the embodiment, the display control module 420 further controls the display unit 30 to display a name 130 of each of the applications associated with shortcut icons 110 when the display unit 30 displays the selectable shortcut icons 110.

In the embodiment, the television control system 40 further includes an executing module 430. The executing module 430 executes the application corresponding to the currently highlighted shortcut icon 110 when the signal receiving module 410 receives a second signal, and switches from the current displayed content to a previous displayed content when the signal receiving module 410 receives a third signal.

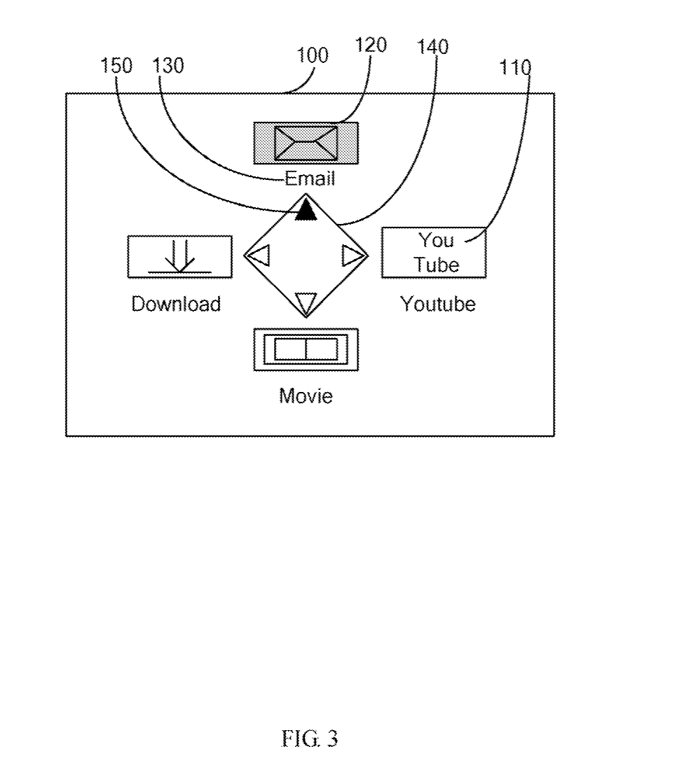

In a first embodiment, the signal receiving module 410 receives signal from a remote control 2 or switches 102 actuated by the buttons 101 of the television device 1. FIG. 3, illustrates the interface 100 further shows a menu item 140. The shortcut icons 110 are displayed in a preset order. In the embodiment, there are four shortcut icons 110 displayed on the display. For example, the email shortcut icon 110 is arranged above the menu item 140, the movie shortcut icon 110 is arranged below the menu item 140, the download shortcut icon 110 is located to the left of the menu item 140, and the Youtube® shortcut icon 110 is located to the right of the menu item 140. In other embodiments, there may be only one or there may be two or more shortcut icons 110. The menu item 140 includes a number of virtual buttons 150. In the embodiment, the virtual buttons 150 include an upper virtual button 150, a lower virtual button 150, a left virtual button 150, and a right virtual button 150. In other embodiments, there may be only one or there may be two or more virtual buttons 150 employed. Each virtual button 150 corresponds to one shortcut icon 110 and corresponds to one button 201 of the remote control 2 or one button 101 on the television device 1. For example, the upper virtual button 150 corresponds to the email shortcut icon 110 and corresponds to the upper button 201 of the remote control 2 or the upper button 101 on the television device 1.

The executing module 430 determines which of the buttons 201 of the remote control 2 or buttons 101 on the television device 1 is depressed when the signal receiving module 410 receives a fourth signal, and determines the virtual buttons 150 corresponding to the depressed buttons 201/101, and further changes the box 120 to a shortcut icon 110 corresponding to the determined virtual button 150. For example, when the fourth signal includes a upper button information, the executing module 430 changes the box 120 to the email shortcut icon 110.

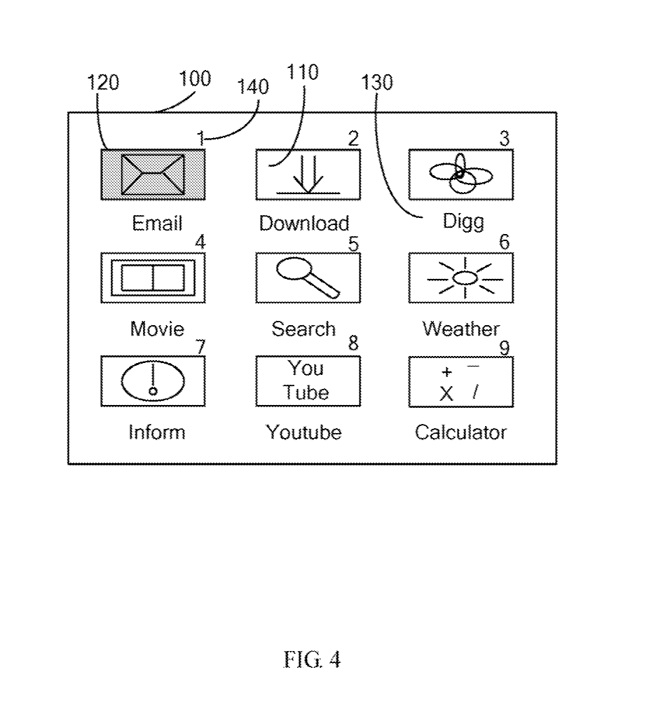

In a second embodiment, the signal receiving module 410 receives signals from a remote control 2. FIG. 4, illustrates the interface 100 further includes numerals displayed adjacent to the short icons. In the embodiment, there are nine shortcut icons 110. For example, the shortcut icons 110 are arranged in three rows and three columns. In a first row, the email shortcut icon 110, the download shortcut icon 110, and the Digg® shortcut icon 110 are displayed from left to right. In a second row, the movie shortcut icon 110, the search shortcut icon 110, and the weather shortcut icon 110 are displayed from left to right. In a third row, the inform shortcut icon 110, the Youtube® shortcut icon 110, and the calculator shortcut icon 110 are displayed from left to right. In other embodiments, the number and arrangement of the shortcut icons 110 can be varied according to need. Each virtual numeral corresponds to one shortcut icon 110, and corresponds to one button 201 of the remote control 2, for example, numeral “1” corresponds to email shortcut icon 110, and corresponds to the button “1” of the remote control 2.

The executing module 430 determines which of the buttons 201 of the remote control 2 is depressed when the signal receiving module 410 receives a fifth signal, determines the numeral corresponding to the depressed buttons 201, and further changes the box 120 to a selectable shortcut icon 110 corresponding to the determined numeral. For example, when determining that the button “4” of the remote 2 is depressed, the executing module 430 changes the box 120 to the movie shortcut icon 110 that corresponds to the numeral 4 corresponding to the button “4” of the remote 2.

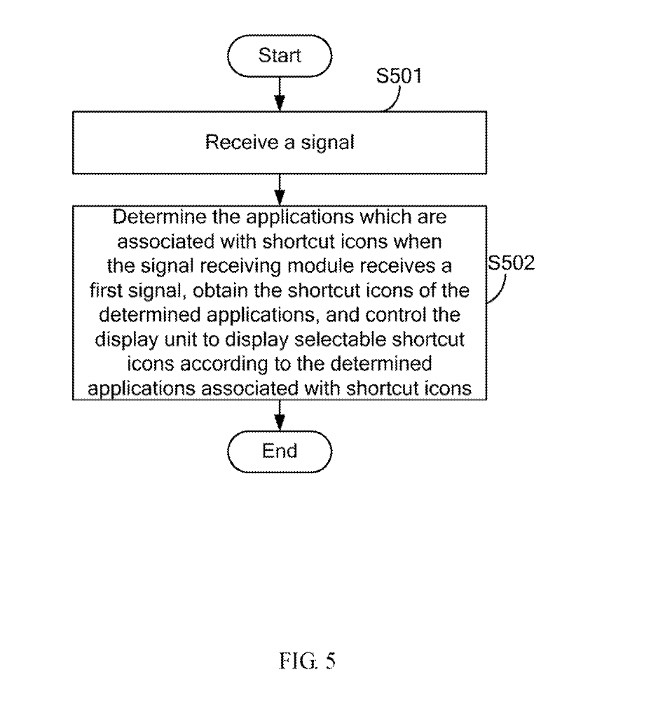

FIG. 5 shows a flowchart of a television control method.

In step S501, the signal receiving module 410 receives a signal.

In step S502, the display control module 420 determines that the one or more applications of the television device 1 are associated with shortcut icons 110 when the signal receiving module 410 receives the signal, obtains the shortcut icons 110 of the determined applications of the television device 1, and controls the display unit 30 to display an interface 100 showing a number of selectable shortcut icons 110 according to the obtained shortcut icons 110 of the determined applications, and make the displayed one or more shortcut icons 110 selectable.

In the embodiment, the display control module 420 further controls the display unit 30 to display a box 120 covering one selectable shortcut icon 110 to indicate that the one selectable shortcut icon 110 is a currently highlighted shortcut icon 110.

In the embodiment, the display control module 420 controls the display unit 30 to display a name 130 of each of the applications associated with shortcut icons 110 when the display unit 30 displays the selectable shortcut icons 110.

In the embodiment, the executing module 430 executes the application corresponding to the currently highlighted shortcut icon 110 when the signal receiving module 410 receives a second signal

In the embodiment, the executing module 430 switches from the current displayed content to a previous displayed content when the signal receiving module 410 receives a third signal.

In a first embodiment, the executing module 430 determines which of the buttons 201 of the remote control 2 or buttons 101 on the television device 1 is depressed when the signal receiving module 410 receives a fourth signal, and determines the virtual buttons 150 corresponding to the depressed button 201/101, and further changes the box 120 to a selectable shortcut icon 110 corresponding to the determined virtual button 150.

In a second embodiment, the executing module 430 determines which of the buttons 201 of the remote control 2 is depressed when the signal receiving module 410 receives the fifth signal, determines the numeral corresponding to the depressed buttons 201, and further changes the box 120 to a selectable shortcut icon 110 corresponding to the determined numeral.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A television device installed with a plurality of applications to provide different functions, one or more of the applications being associated with one or more shortcut icons which allows a user to launch the one or more of the applications, the television device comprising:
a storage unit;
a processor;
a display;
one or more programs stored in the storage unit, executable by the processor, the one or more programs comprising:
a signal receiving module operable to receive signals; and
a display control module operable to determine the one or more applications of the television device which are associated with shortcut icons when the signal receiving module receives a first signal, obtain the shortcut icons of the determined one or more applications of the television device, and control the display unit to display an interface showing one or more selectable shortcut icons according to the obtained one or more shortcut icons of the determined one or more applications, and make the displayed one or more shortcut icons selectable.

2. The television device as described in claim 1, wherein the display control module further controls the display unit to display a box covering one selectable shortcut icon to indicate that the one selectable shortcut icon is a currently highlighted shortcut icon.

3. The television device as described in claim 2, further comprising an executing module to execute the application corresponding to the currently highlighted shortcut icon when the signal receiving module receives a second signal.

4. The television device as described in claim 1, wherein the display control module is further to control the display unit to display a name of each of the one or more applications associated with shortcut icons when the display unit displays the one or more selectable shortcut icons.

5. The television device as described in claim 1 further comprising an executing module to switch from the current displayed content to a previous displayed content when the signal receiving module receives a third signal.

6. The television device as described in claim 2, wherein the signal receiving module receives signal from a remote control or switches actuated by the buttons on the television, the shortcut icons are displayed in a preset order, the interface further shows a menu item which comprises one or more virtual buttons, each of the one or more virtual buttons corresponds to one of the one or more shortcut icons, and corresponds to one button of a remote control or one button on the television.

7. The television device as described in claim 6 further comprising an executing module, wherein the executing module is to determine which of the buttons of the remote control or buttons on the television is depressed when the signal receiving module receives the fourth signal, determine the virtual button corresponding to the depressed button, and further changes the box to a selectable shortcut icon corresponding to the determined virtual button.

8. The television device as described in claim 2, wherein the signal receiving module receives signal from a remote control, the interface further comprises one or more numerals, each of the one or more numerals corresponds to one of the one or more selectable shortcut icons, and corresponds to one of the buttons of the remote control.

9. The television device as described in claim 8 further comprising an executing module, wherein the executing module is to determine which of the buttons of the remote control is depressed when the signal receiving module receives the fifth signal, determine the numeral corresponding to the depressed button, and further change the box to a selectable shortcut icon corresponding to the determined numeral.

10. A television control method implemented by a television device, the television device installed on a plurality of applications to provide different functions, one or more of the applications being associated with one or more shortcut icons which allows a user to launch the one or more of the applications, the television device comprising a display unit, the television control method comprising:
receiving a signal; and
determining the one or more applications of the television device which are associated with the shortcut icons upon receiving a first signal, obtaining the shortcut icons of the determined one or more applications of the television device, and controlling the display unit to display an interface showing one or more selectable shortcut icons according to the obtained one or more shortcut icons of the determined one or more applications, and make the displayed one or more shortcut icons selectable.

11. The television control method as described in claim 10, wherein the method further comprises:
controlling the display unit to display a box covering one selectable shortcut icon to indicate that the one selectable shortcut icon is a currently highlighted shortcut icon.

12. The television control method as described in claim 11, wherein the method further comprises:
executing the application corresponding to the currently highlighted shortcut icon upon receiving a second signal.

13. The television control method as described in claim 10, wherein the method further comprises:
controlling the display unit to display a name of each of the one or more applications associated with shortcut icons when the display unit displays the one or more selectable shortcut icons.

14. The television control method as described in claim 10, wherein the method further comprises:
switching from the current displayed content to a previous displayed content upon receiving a third signal.

15. The television control method as described in claim 11, wherein the signals are received from a remote control or switches actuated by the buttons on the television, the shortcut icons are displayed in a preset order, the interface further shows a menu item which comprises one or more virtual buttons, each of the one or more virtual buttons corresponds to one of the one or more shortcut icons, and corresponds to one button of a remote control or one button on the television.

16. The television control method as described in claim 15, wherein the method further comprises:
determining which of the buttons of the remote control or buttons on the television is depressed upon receiving the fourth signal, determine the virtual button corresponding to the depressed button, and further changing the box to a selectable shortcut icon corresponding to the determined virtual button.

17. The television control method as described in claim 11, wherein the signals are received from a remote control, the interface further comprises one or more numerals, each of the one or more numerals corresponds to one of the one or more selectable shortcut icons, and corresponds to one of the buttons of the remote control.

18. The television control method as described in claim 17, wherein the method further comprises:
determining which of the buttons of the remote control is depressed upon receiving the fifth signal, determining the numeral corresponding to the depressed button, and further changing the box to a selectable shortcut icon corresponding to the determined numeral.
